(19) United States
(12) Patent Application Publication
(10) Pub. No.: US 2016/0117063 A1
(43) Pub. Date: Apr. 28, 2016

(54) SYSTEMS AND METHODS FOR MANAGING HASHTAGS

(71) Applicant: rocket-fueled, Inc., Huntsville, AL (US)

(72) Inventor: David A. Fuller, Decatur, AL (US)

(21) Appl. No.: 14/921,757

(22) Filed: Oct. 23, 2015

Related U.S. Application Data
(60) Provisional application No. 62/067,843, filed on Oct. 23, 2014.

(51) Int. Cl. G06F 3/0482; G06F 17/30; G06F 3/0481; H04L 29/06; G06F 3/0484; H04L 29/08

(52) U.S. Cl. CPC G06F 3/0482; G06F 3/04842; H04L 67/02; G06F 3/04817; H04L 65/403; G06F 17/30867

(57) ABSTRACT

A hashtag management system permits a user to review a ranked or unranked list of hashtags that are correlated with an object of interest and to manipulate the list, such as by adding or deleting hashtags or by rearranging the ranking and to use the list for the purposes of contextual search and/or discovery. Based on the inputs of multiple users manipulating the hashtags, the system determines trends and/or preferences, search and/or discovery priorities and provides information about the trends and/or preferences to users who may use such information in order to select one or more of the hashtags for sharing across a social media platform and/or for the purposes of search and/or discovery. Additionally, the system facilitates the process by which the selected hashtags are shared across social media platforms in conjunction with the corresponding object and/or searching and/or discovering related objects.

### CROSS-REFERENCE TO RELATED APPLICATIONS

This application claims the benefit of U.S. Provisional Application No. 62/067,843, entitled “Systems and Methods for Managing Hashtags,” and filed Oct. 23, 2014, which application is hereby incorporated by reference in its entirety.

### RELATED ART

A social network hashtag is conventionally a word or unspaced phrase preceded by the symbol #. Conventionally, a hashtag may refer to an event, thing, description, or person that has gained or is seeking newsworthy status across a social network platform. The hashtag may capture instant moments in time and be related to celebrities, politicians, natural disasters, corporate brands, etc. If a consensus forms within the social network community where the hashtag appears, the topic associated with the hashtag may “trend,” i.e., gather additional views, commentary and followers.

Hashtags can be subjectively composed and may not always follow established and conventional grammar or spelling techniques. Due to its subjective origination, a particular hashtag may have more meaning to certain individuals or groups than another hashtag that strives to describe the same event, thing, or person; or convey the same meaning. In some cases, hashtags may be categorized around a singular event, thing, description, or person; however, in other cases hashtags may be a shorthand form of expressing emotion, for example, such as the hashtags (#TooMuchInformation, #Awesome).

As described above, for a particular hashtag to trend there has to be an adopted consensus of the worth, value, or interest of the topic associated with the hashtag. Additionally, a secondary consensus about the hashtag itself may arise, given the multitude of ways the hashtag could be subjectively constructed. A need exists to provide users of a social network an avenue to form and adopt a consensual hashtag.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating an exemplary embodiment of a hashtag management system.

FIG. 2 is a block diagram illustrating an exemplary embodiment of a hashtag management server, such as is depicted by FIG. 1.

FIG. 3 depicts an exemplary graphical user interface (GUI) rendered by the hashtag management server when a user has selected a rate hashtag option.

FIG. 4 depicts the GUI of FIG. 3 when a user has selected a share hashtags option.

FIG. 5 depicts the GUI of FIG. 3 when the user has selected a hyperlink for sharing hashtags via a particular social media platform.

FIG. 6 is a flowchart illustrating an exemplary method of rating and sharing hashtags.

### DETAILED DESCRIPTION

The present disclosure generally pertains to systems and methods for managing hashtags. In one exemplary embodiment, a hashtag management system permits a user to review a ranked or unranked list of hashtags that are correlated with an object of interest and to manipulate the list, such as by adding or deleting hashtags or by rearranging the ranking and to use the list for the purposes of contextual search and/or discovery. Based on the inputs of multiple users manipulating the hashtags, the system determines trends and/or preferences and search and/or discovery priorities. The system provides information about the trends and/or preferences to users who may use such information in order to select one or more of the hashtags for sharing in conjunction with the corresponding object and/or other information thereto related across a social media platform and/or for the purposes of search and/or discovery. Additionally, the system facilitates the process by which the selected hashtags are shared in conjunction with the corresponding object and/or other information thereto related across social media platforms and/or the process for searching and/or discovering related objects. While this disclosure teaches methodologies pertaining to hashtags, it is contemplated that the same methodologies may be used for geographical or location tags known euphemistically as “geotags.” Thus, geotags are electronic tags assigned to postings on social media websites, still photographs, and videos to indicate the geographical location corresponding to the capture or initiation of the relevant content. Therefore, the term “tags” may refer to either hashtags and/or geotags regardless of source, place or means of entry into a user interface which utilizes the systems and methods described herein. For purposes of describing the operation of these systems and methods the terms hashtag and geotag and/or other identifiers are interchangeable.

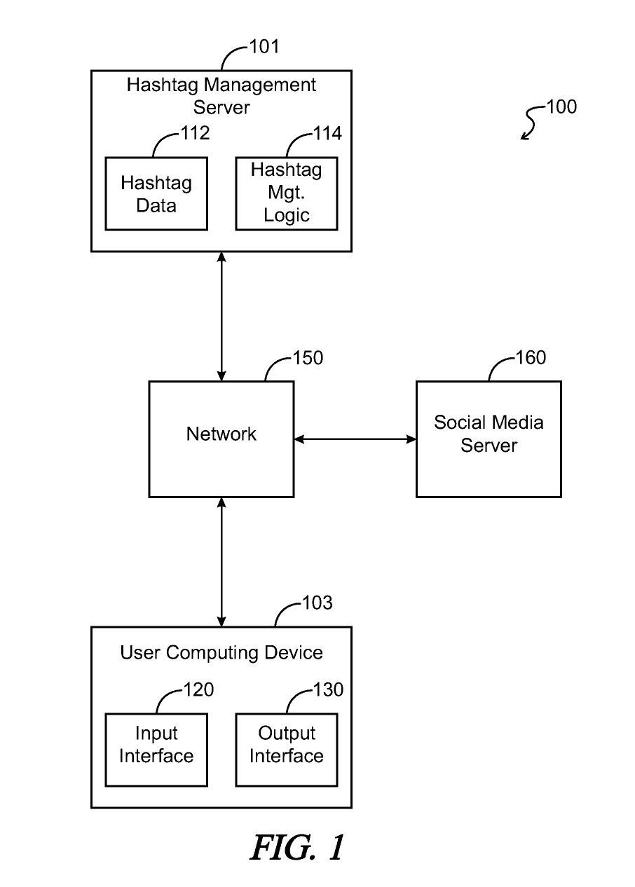

FIG. 1 depicts an exemplary embodiment of a hashtag management system 100.

As shown by FIG. 1, the system 100 includes a hashtag management server 101 that is configured to communicate with a user computing device 103 via a network 150, such as a local area network (LAN) or a wide area network (WAN). In one exemplary embodiment, the network 150 can be the Internet, and the hashtag management server 101 communicates across the network 150 via transmission control protocol/Internet protocol (TCP/IP), but other protocols may be used in other embodiments.

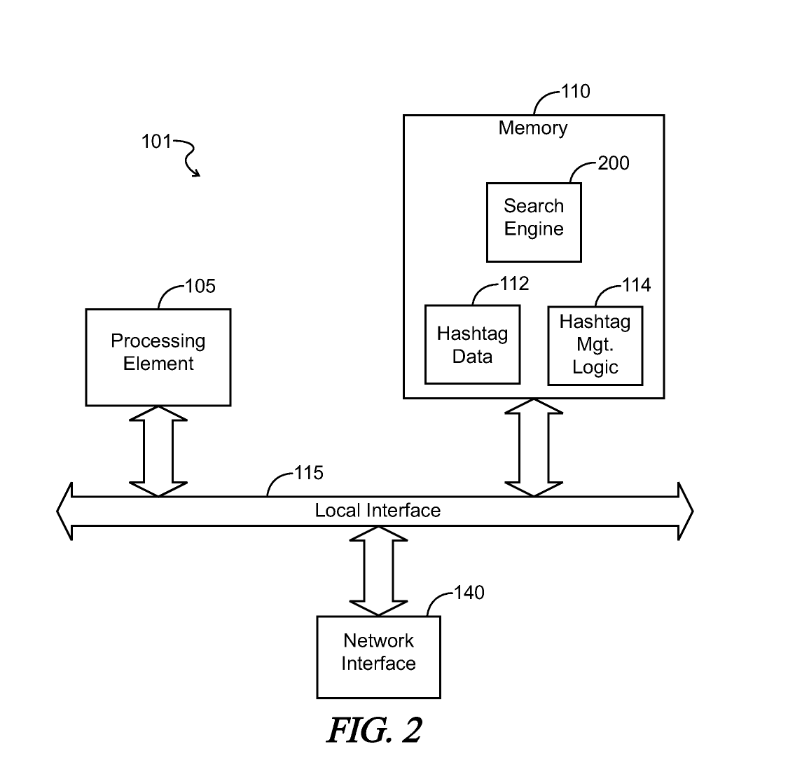

As shown by FIG. 1, the hashtag management server 101 includes hashtag management logic 114 for generally controlling the operation of the server 101 and the user device 103, as will be described in more detail hereafter. The logic 114 can be implemented in software, hardware, firmware or any combination thereof. In the exemplary server 101 illustrated by FIG. 2, the logic 114 is implemented in software and stored in memory 110 of the server 101.

Note that the logic 114, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus. In addition, at least a portion of the logic 114 may be downloaded to and operate on the user device 103 so that communication between elements of the user device 103, such as input interface 120 and output interface 130, do not need to be communicated over the network 150 during operation. The user computing device 103 may include memory (not specifically shown) for storing instructions of the logic 114 and a processing element, such as a digital signal processor (DSP) or a central processing unit (CPU), for executing such instructions.

The exemplary server 101 depicted by FIG. 2 includes at least one conventional processing element 105, such as a DSP or CPU, that communicates to and drives the other elements within the server 101 via a local interface 115, which can include at least one bus. Furthermore, a network interface 140, such as at least one modem, may be used to exchange data with the network 150. In one embodiment, the server 101 can also include an input interface (not shown), for example, a keyboard or a mouse, that can be used to input data from a user of the server 101, and an output interface (not shown), for example, a printer, monitor, liquid crystal display (LCD), or other display apparatus, that can be used to output data to the user. As shown by FIG. 2, the server 101 stores hashtag data 112, which will be described in more detail below.

Referring again to FIG. 1, the user computing device 103 may be any device capable of communicating with the network 150. As an example, the device 103 may be a desktop or laptop computer or a hand-held device, such as a smartphone. The user device 103 has an input interface 120, such as a keyboard, keypad, or mouse, that allows a user to provide inputs, and the user device 103 also has an output interface, such as a display screen or printer, for providing outputs to a user. In one exemplary embodiment, a touchscreen that both receives input and provides output is used to implement both the input interface 120 and the output interface 130. In other embodiments, yet other types of input and output devices may be used.

The network 150 may be communicatively coupled to one or more social media servers 160 that provide social media platforms to allow users to communicate in a social network, such as Twitter, Facebook, Google+, or Instagram, for example.

In one exemplary embodiment, the logic 114 hosts a webpage that may be accessed by user computing device 103 and displayed via the output interface 130. As an example, the server 101 may host a webpage for auctioning or otherwise selling an object, and the hashtag data 112 may define a list of hashtags correlated with and descriptive of the object. The logic 114 is configured to transmit the webpage and hashtag data 112 to the user computing device 103 via the network 150 for display on the output interface 130. As an example, the data 112 may define a list of hashtags that are displayed via the output interface 130.

Note that the list of hashtags may be generated by users submitting and rating hashtags, as will be described in more detail hereafter. Further, in one exemplary embodiment, the hashtags appear in a ranked order based on how the hashtags are progressively rated by users. As an example, the logic 114 may receive ratings from multiple users and average the ratings for each respective hashtag in order to rank the hashtags within the displayed list. In one exemplary embodiment, the server 101 implements a social media platform, referred to herein as “primary social media platform,” that allows users to communicate with one another, including sharing comments and hashtags. The logic 114 may be configured to track such communications and define the hashtags based on the communications. For example, the logic 114 may derive the list of hashtags from hashtags received from or shared by users in the social network environment provided by the server 101. The logic 114 may also rank the hashtags based on their popularity as indicated by the ratings received from users and/or by tracking how often the hashtags are shared among users. Further, the logic 114 may contact the server 160 and glean similar information about hashtags communicated via the social media platform, referred to hereafter as “secondary social media platform,” implemented by the server 160. Indeed, the logic 114 may combine results or information from multiple social media platforms in order to define and/or rank hashtags, as further described below. In other embodiments, yet other techniques for defining and ranking the hashtags are possible.

When the hashtag list is displayed to the user of the device 103, he or she may apply subjective and critical assessment about the relative descriptiveness of each presented hashtag with respect to the corresponding object. Note that a user may provide inputs via the input interface 120 for rating the hashtags, as well as adding or deleting hashtags. Such inputs are communicated to the logic 114, which may adjust the list of hashtags in the data 112 based on such inputs. Thus, the list of hashtags and, specifically, the ranking of hashtags within the list reflect trends and/or preferences in users' subjective assessment about the descriptiveness or value of the hashtags relative to one another.

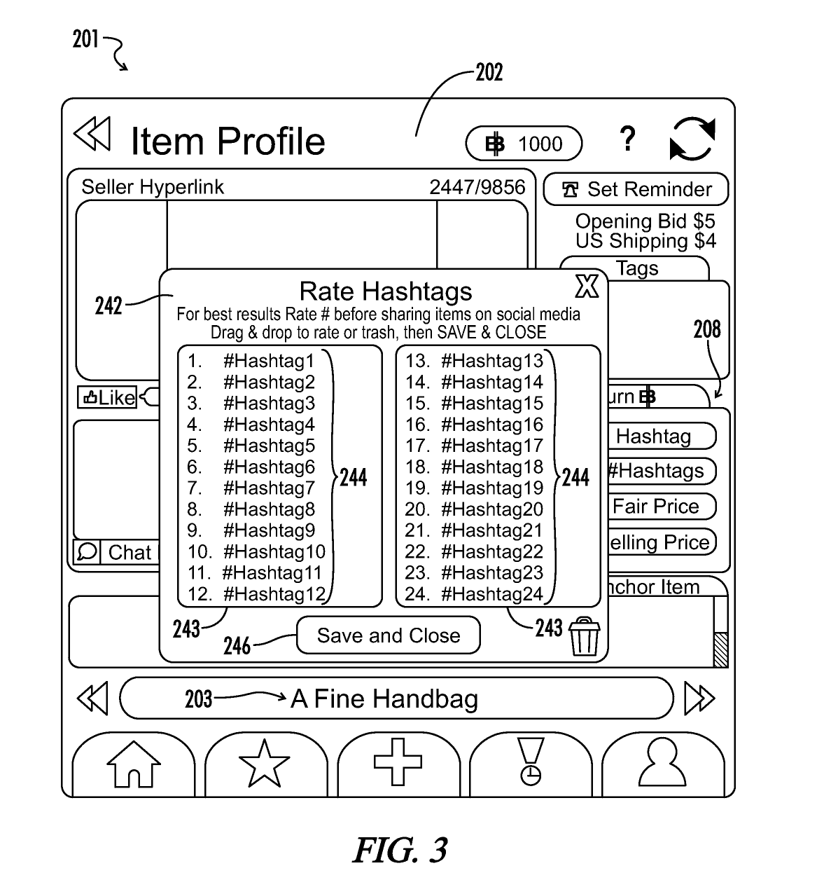

FIG. 3 illustrates an exemplary graphical user interface (GUI) 201 that is displayed by the logic 114 on the output interface 130. The exemplary GUI 201 shown by FIG. 3 includes a screen 202 that is specifically designed for auctioning an object by allowing users to bid on the object for purchase. As shown by FIG. 3, the screen 202 is labeled “Item Profile” and shall also be referred to herein as “Item Profile screen.” The Item Profile screen 202 includes multiple informational and interactive selection points for controlling the display of information and reception of inputs. For example, the Item Profile screen 202 may further include an object title area 203. The object title area 203 in this example contains the title, “A Fine Handbag.” Hence, the object or item that is being profiled for auction in the instant example is a handbag, although other objects are possible in other examples.

Additional user selected choices on the Item Profile screen 202 include hashtag display options 208. When the user selects one of the hashtag display options 208, an overlay or pop-up window appears to give the user greater detail about the hashtags used for the handbag.

In the embodiment shown in FIG. 3, the user has selected one of the hashtag options 208 that permits the user to rate hashtags that are descriptive of and are associated with the handbag, i.e., an item soon to be or currently up for bid or otherwise for sale via the online auction. As such, a pop-up window 242 for rating hashtags appears as an overlay in front of the Item Profile screen 202. The rate hashtag pop-up window 242 includes one or more display areas 243 in which at least one list of hashtags 244 is displayed. As shown in FIG. 3, the hashtag list 244 is displayed in a sequential, numerical order. However, in other embodiments, the hashtag list 244 can be displayed in other orders or arrangements such as alphabetical or by groups that include a particular keyword or phrase. The hashtag list 244 may include any number of hashtags that have been captured by the logic 114 as descriptive of the handbag in this example.

The user is prompted to reorder the hashtag list 244 by performing dragging and dropping operations on the hashtag list 244 or submitting other types of user inputs. As an example, the user may delete one or more hashtags from the hashtag list 244. In addition, the user may reorder the hashtag list 244 by dragging an earlier listed hashtag from one position (e.g., position #3) to another position (e.g., position #29) or providing some other input for moving the hashtags within the list. The user may repeatedly and subjectively perform such hashtag manipulations until the hashtag order meets his/her satisfaction in best describing the object associated with the hashtags (e.g., the handbag that is soon to be or currently up for bid or otherwise for sale in the instant example). In this regard, the user may update the hashtag list 244 such that the hashtags are ranked in a desired order according to the user's subjective opinion. As an example, the user's most favorite hashtag may be at the top of the list 244, and the user's least favorite hashtag may be at the bottom of the list 244. Hashtags that the user deems irrelevant and/or inappropriate may be deleted altogether.

Once the user is satisfied with his/her new organizational or ordering scheme for the hashtag list 244, the user may press or select a save icon 246, herein labeled “Save and Close,” in order to save the new organizational or ordering scheme for the hashtag list 244. Therefore, the logic 114 stores the new organizational or ordering scheme for the hashtag list 244 in memory 110 and closes the window 242.

In one exemplary embodiment, the logic 114 maintains several hashtag lists in the hashtag data 112. As an example, the logic 114 stores the list rearranged by the user, described hereafter as a “private hashtag list.” In addition to being correlated with the object (e.g., handbag), the private hashtag list is also correlated with a user identifier that uniquely identifies the user so that this private hashtag list can be later retrieved and used by the user, as may be desired.

The logic 114 also stores in the hashtag data 112 another hashtag list, referred to hereafter as “global hashtag list,” that is correlated with the object (e.g., handbag). Such global hashtag list may be ranked according to the ratings of multiple users. As an example, the logic 114 may analyze the private hashtag lists of many users for the same object and define the global hashtag list based on such analysis. In this regard, the logic 114 may average or otherwise mathematically combine the hashtag ratings of many users, as indicated by the users' private hashtag lists stored in the data 112, in order to generate ratings for the hashtags in the global hashtag list. As described above, the global hashtag list and the ranking of the hashtags within such list may be based on information gleaned from communications of users in one or more social networking environments. The global hashtag list may be viewed by users to see the trending or favorite hashtags correlated with the object of interest.

Note that this global hashtag list may be collected and maintained in a single database repository correlated with the object and/or its other identifiers. A similar global list of all hashtags and/or other identifiers entered by any user may also be collected and maintained in a single database repository correlated with each user. A similar global list of objects correlated with the hashtags or other identifiers may also be collected and maintained in a single database repository correlated with each hashtag and/or other identifier.

In one exemplary embodiment, the global hashtag list is defined by the provider of the object (e.g., handbag) to be sold or otherwise provided. Thereafter, the global hashtag list may be updated based on the private hashtag lists of other users, as described in more detail herein. The logic 114 is configured to control the hashtag data 112 such that each hashtag is correlated with certain information, referred to herein as “metadata.” The metadata of a given hashtag indicates the origin of the hashtag, such as a user identifier of the user who created the hashtag. Alternatively, the origin may indicate the type of user that created the hashtag, such as whether such user is the provider or consumer of the object (e.g., handbag) correlated with the hashtag. The metadata also defines a timestamp indicating the date and time of creation of the hashtag. A geostamp indicating the user's location when the hashtag was entered may also be recorded in the metadata. In other embodiments, other types of metadata are possible.

In one exemplary embodiment, for each hashtag in the hashtag data 112, the logic 114 is configured to update the hashtag data 112 to link the hashtag with each object that is tagged with the hashtag by a user of the system 100 regardless of whether the user created the hashtag. As an example, assume that the provider of the handbag creates a particular hashtag when creating a global hashtag list, as described above. If a user posts a comment that uses such hashtag in order to tag a different object, the logic 114 is configured to link the hashtag with the foregoing object. Thus, any user may request that the logic 114 search the hashtag data 112 in order to retrieve and display to the user each object that is linked to a given hashtag or set of hashtags.

Note that when the pop-up window 242 is initially displayed, the global hashtag list correlated with the object of interest may be displayed within the window 242. Thus, by viewing the list, the user may see which hashtags are the favorites of other users and/or which hashtags are trending in one or more social networking environments. If the user disagrees with the ranking indicated by the global hashtag list, the user may rearrange or otherwise modify the list, as described above, thereby defining the user's private hashtag list. Once the user submits his private list for storage, the logic 114 may update the global hashtag list that is correlated with the same object. As an example, the logic 114 may average the user's ratings, as indicated by his private hashtag list, with those of other users so that the global hashtag list is continually updated as more and more users rate the hashtags of the correlated object.

Note that, as described above, the logic 114 may rate the global hashtag list based on other factors in addition to or in lieu of the subjective ratings submitted by users as indicated by their private hashtag lists. As an example, as will be described in more detail hereafter, the system 100 allows a user to share hashtags. The logic 114 may be configured to track such sharing and to factor in the extent to which a particular hashtag is shared when rating such hashtag. As an example, a hashtag that is shared more often may be rated higher. In one exemplary embodiment, the logic 114 combines the subjective ratings of multiple users with data indicative of the extent to which the hashtags are shared in order to define an overall rating for each hashtag in the global hashtag list, and the logic 114 thereafter ranks the hashtags according to their calculated ratings. In addition, when the hashtag list 244 is displayed, information indicative of the extent to which each hashtag has been shared may be displayed to the user so that the user may consider such data when selecting the hashtags. Note that the sharing information may be gleaned from the hashtags shared via the primary social media platform provided by the server 101. In addition, the logic 144 may be configured to contact the social media server 160 in order to obtain information about sharing that occurs via the secondary social network platform implemented by the server 160.

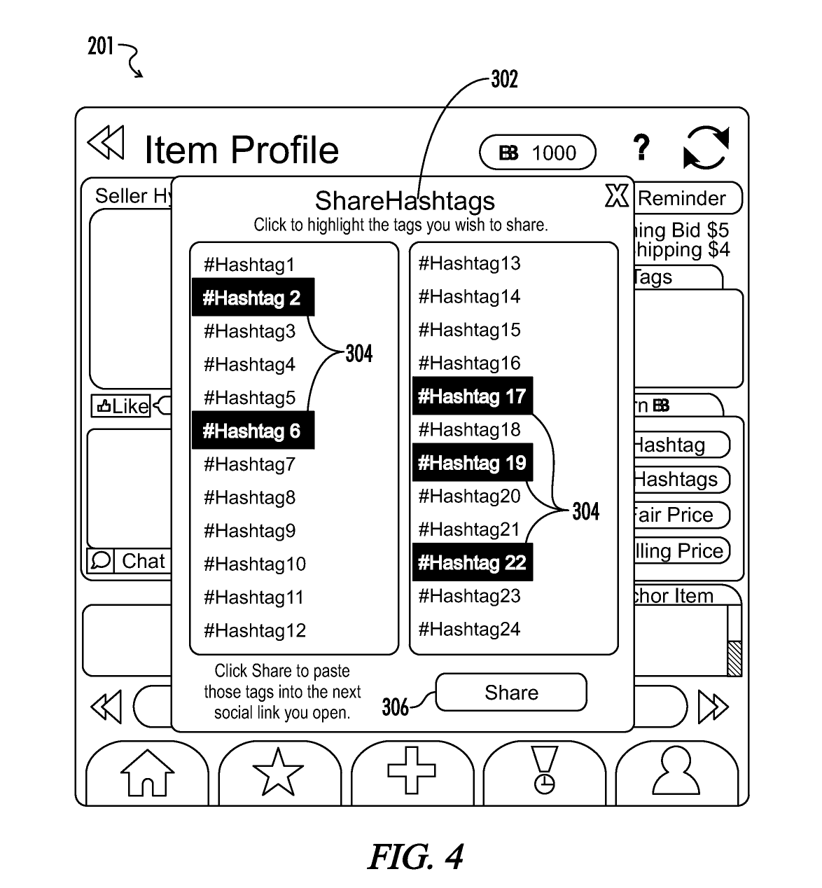

As briefly described above, one of the hashtag options 208 permits the user to share hashtags. When the user selects a hashtag option 208 to share hashtags, the logic 114 displays a screen 302 (FIG. 4) for permitting the user to select hashtags for sharing. The hashtag list displayed within the screen 302 may be the private hashtag list previously defined by the user or alternatively the global hashtag list maintained by the logic 114. As described above, when the global hashtag list is displayed, the user can discern which of the hashtags are the most popular among the users that have previously rated the hashtags in the list. The user is prompted to select one or more hashtags from the displayed list for sharing. In one exemplary embodiment, the selected hashtags are for sharing with users of the secondary social media platform, although it is possible for the selected hashtags to be shared within the primary social media platform implemented by the server 101. In this regard, the secondary social media platform (e.g., Twitter or Facebook) is hosted by the server 160, and the selected hashtags are to be transmitted via network 150, such as the Internet, to the server 160, which posts the selected hashtags in the social networking environment of the social media platform. For example, in a Twitter environment, the selected hashtags may be “tweeted.”

In one exemplary embodiment, as the user selects hashtags for sharing, the selected hashtags are highlighted by the logic 114. The exemplary display screen 302 of FIG. 4 shows five highlighted hashtags 304 that have been selected by the user for sharing. In the instant example, the highlighted hashtags 304 include #Hashtag2, #Hashtag6, #Hashtag17, #Hashtag19 and #Hashtag22. The highlighted hashtags 304 may have been selected by the user for sharing because of the user's inherent belief in their value within the social media platform implemented by the server 160 and/or their being uniquely descriptive of the corresponding object and/or of the user's assessment thereof. Thus, the user may believe that the highlighted hashtags 304 will trend well in the social media platform and ultimately will be well-accepted by the social community connected to the social media platform and/or distinguish them in the community. When the user has selected all of the hashtags that he desires to share, the user next selects a share icon 306.

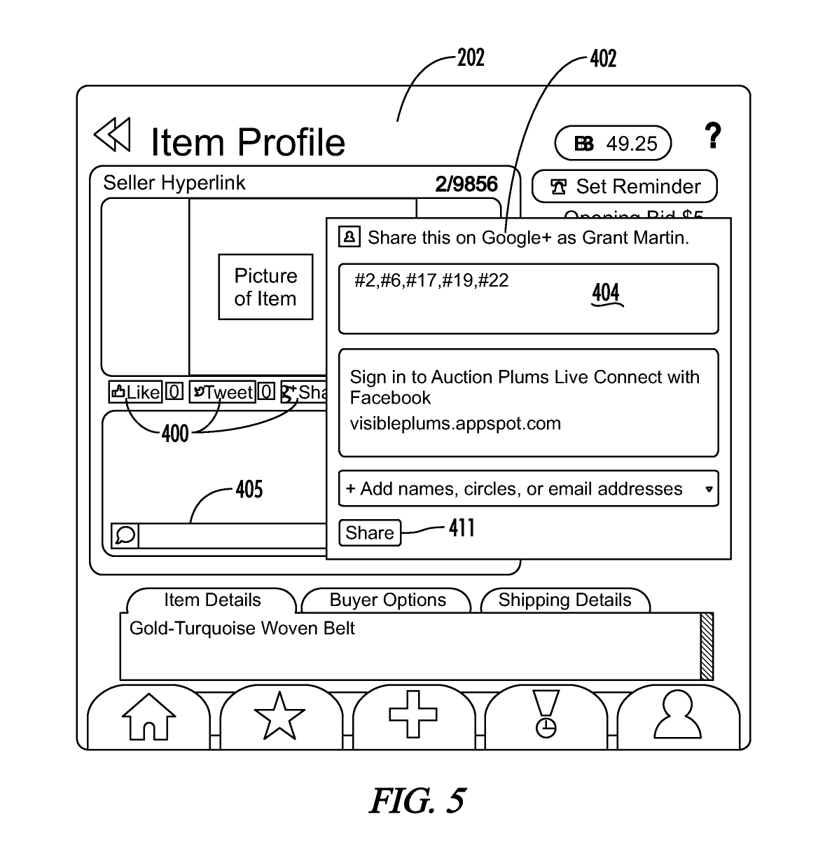

In response to selection of the share icon 306, the logic 114 closes the screen 302 and causes the device 103 to write the hashtags to a local clipboard of the device 103 in order to permit automatic pasting of the hashtags, as will be described in more detail below. After screen 302 is closed, the user may select one of a plurality of selectable objects 400 (see FIG. 5), e.g., icons with hyperlinks, on the screen 202 corresponding to the secondary social media platform the user wishes to use for sharing the selected hashtags. In this regard, each respective hyperlink 400 is correlated with a particular social media platform, such as Facebook, Twitter, or Google+, as depicted by FIG. 5. If desired, the user may write a comment related to the sharing of the hashtag in a field(s) 405 of the screen 202.

The user selects a desired object or icon 400 for the secondary social media platform in which the user desires to share the selected hashtags. In response, the logic 114 contacts the server 160 of such secondary social media platform and logs into the user's account. As an example, as part of the login process, the user may be prompted for a username and password in order to authenticate the user to the server 160. Alternatively, such information may be stored in memory 110 of the hashtag management server 101 or device 103, and the logic 114 may automatically log into the user's account based on such pre-stored information. In this regard, the user may provide such information to the server 101 in a registration phase before using the server 101. The logic 114 may be configured to use this information in order to automatically log into the user's account managed by the social media server 160.

In any event, the user is provided access to the secondary social media platform by clicking on an object or icon 400 correlated to the secondary social media platform that the user wants to use for sharing the highlighted hashtags 304. FIG. 5 shows the screen 202 as the user is selecting an object or icon 400 from one of several available objects or icons 400. When the user selects an object or icon 400, the logic 114 is configured to display a pop-up window 402 that includes an area 404 in which hashtags may be written for sharing. As noted above, the hashtags selected by the user for sharing were written to a local clipboard of the device 103 when the user selected the share icon 306 depicted by FIG. 4. In response to selection of an object or icon 400, the logic 114 displays the window 402 and causes the user computing device 103 to write the hashtags from the device's clipboard to the area 404, thereby facilitating the process of populating the window 402 with the desired hashtags for sharing. In the instant example, the highlighted hashtags 304 are pasted as #Hashtag2, #Hashtag6, #Hashtag17, #Hashtag19 and #Hashtag22 for viewing by the larger social community connected to the secondary social platform.

In addition, if the user provided a comment in the field 405, the comment may be automatically written by the logic 114 into the window 402 along with the hashtags. Alternatively, the user may manually type a desired comment into the window 402 or otherwise modify the window 402, such as manually adding or deleting hashtags. Once the user is satisfied, the user selects a share icon 411. In response, the logic 114 transmits the data of the window 402 to the social media server 160. Note that external share links provided by the social media server 160 may be used to create the window 402 and/or communicate the windows data with the social media server 160. Upon receiving the data, the social media server 160 shares the hashtags and comment, if provided, with users of its secondary social media platform through the account of the user of the computing device 103. As an example, in a Facebook environment, the hashtags and comment may be shared with the user's “friends.”

At this point, the larger social community may choose to accept one or more of the highlighted hashtags 304 as appropriately descriptive of the object and therefore choose to subsequently use (e.g., share) one of the hashtags in later discussion about the object, thus causing at least one of the highlighted hashtags 304 to trend within the social community.

Note that if desired, the user may select another object or icon 400 in order to share the selected hashtags, as described above, with yet another social media platform implemented by another social media server (not shown). Since the hashtags have been written to a clipboard, the sharing operation may be performed again and again, until the clipboard is overwritten with new data, without the user having to repeat the hashtag selection process.

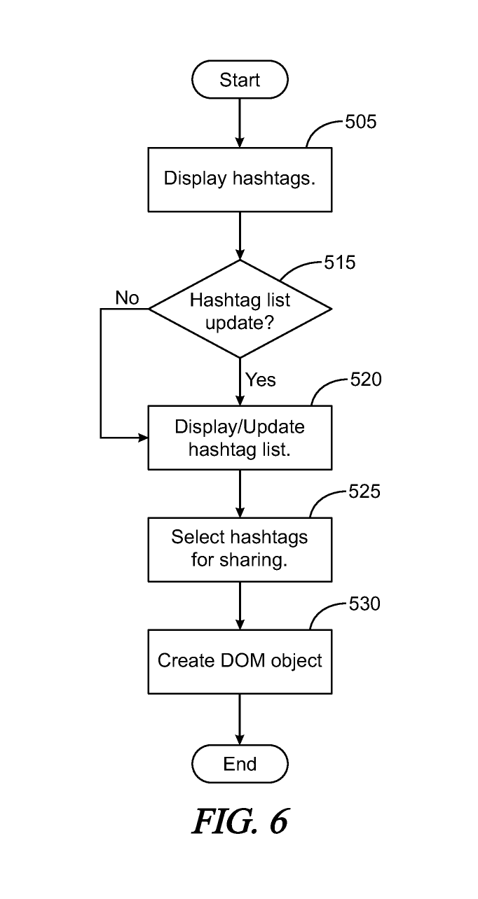

An example flowchart for loading a webpage is depicted in FIG. 6. In one example embodiment, a conventional document object model (DOM) may be employed by logic 114 to render an HTML webpage for a web browser. Logic 114, in block 505, displays hashtags that may be in hashtag data 112 or otherwise available to the logic 114. Logic 114 may create a DOM object for hashtags that may be arrayed and displayed to the user of the device 103. DOM data may be mapped to a data access layer prior to storage in the hashtag data 112. Furthermore, the logic 114 determines whether an update to the hashtag list is to occur based on a user input, e.g., the selection of the rate hashtag option 208, as shown by block 515. Thus, logic 114 may be configured, as shown in block 520, to display a hashtag list for possible updating, such as moving hashtags within the list, deleting hashtags, or adding hashtags, if the user selection in block 520 was to edit the hashtag list in block 520. If the user's selection in block 515 was not to edit the hashtag list then the hashtag list is continued to be displayed in block 520 for the user's reference. Inside the data access layer or hashtag data 112, a global tag order (i.e., the order for the global hashtag list) is manipulated in order to aggregate ratings and change order or priority for the organized hashtags based on user input.

As depicted in block 525, logic 114 allows selection of hashtags that are to be shared with a secondary social media platform, via the selection of the share hashtag option 208. Specific hashtags may be selected via a GUI, as described above. The logic 114 may, afterwards, create a new DOM object for a list of shared hashtags when it receives an indication that a “share list” has been saved to hashtag data 112, as shown by block 530.

The computer system 100 may include logic 114 that is configured to retrieve the “share list” DOM object and append it to a message that is scheduled to be shared on a secondary social media platform. In one embodiment, external share links from the secondary social media platform may be used to post or plug in the “share list” DOM object. The “share list” DOM object may remain persistent in the DOM or alternatively it may be allowed to decay over time. In one embodiment, logic 114 may open a comment section (not shown) at the secondary social media platform for pasting of the shared hashtags.

The systems and methods described herein may be implemented across multiple social networks to broaden and illuminate the appeal of a discoverable hashtag-related trend, thereby increasing the hashtag's potential use and effectiveness across multiple social media platforms. As such, the present disclosure may be utilized for multiple secondary social platforms, simultaneously.

In general, the systems and methods described herein may track shared posts or user submissions across multiple social media platforms and thereby track new hashtags included in the posts. These posts may be analyzed to discover how the new hashtags trend and then subsequently include the new hashtags in the existing array defined by the hashtag data 112.

In one exemplary embodiment, referring to FIG. 2, the hashtag management server 101 has a search engine 200 that is configured to search resources (e.g., websites) in communication with the network 150 based on a keyword query. As an example, the search engine 200 may be configured and operate similar to conventional Internet search engines, such as Google, for searching various websites based on a keyword query submitted by users. Note that the search engine 200 may be implemented in hardware, software, firmware, or any combination thereof. In the exemplary embodiment depicted by FIG. 2, the search engine 200 is implemented in software and stored within memory 110.

As described above, the hashtag management server 101 facilitates the selection or creation of hashtag lists. Once a hashtag list is defined by a user, the user may submit an input requesting that the search engine 200 perform a search of the resources in communication with the network 150 (e.g., an Internet search) for items using the defined hashtag list as a multiple keyword query. As an example, the display screen 302 shown by FIG. 4, may include a button or other object (not shown) that when selected by the user causes the search engine 200 to automatically perform a network and/or an Internet search using the hashtags in the displayed list as a multiple keyword query, thereby facilitating initiation of such a search after the user has arranged the list of hashtags in a desired manner according to the exemplary techniques described above. Alternatively, the user may request that the search engine 200 perform a search using the global hashtag list as the query. In addition, the user may submit a keyword query that is manually input by the user, and such query may include single or multiple hashtags and/or other types of identifiers to be searched. That is, it is unnecessary for the query to include any hashtags at all, or the user may mix hashtags with other keywords and/or identifiers in a query. The ordering and thus ranking of multiple identifiers within a query is editable and subject to addition, subtraction and rearrangement to suit the user's needs, desires, interests, curiosity and/or any other criteria. In one exemplary embodiment, identifiers may be arranged by means of a drag and drop system. Other embodiments may also be employed.

In one exemplary embodiment, the search engine 200 is configured to prioritize its search based on the order of the keywords and/or other identifiers in the query. That is, the search engine 200 is configured to sort the results in an order in which the results deemed to be most relevant to the query are listed first. That is, the results are ranked based on relevancy. For example, the search engine 200 may assign a relevancy score to each result depending on the extent to which the result matches the query. For example, in general, the more words that the result has matching one of the keywords and/or other identifiers in the query, the higher is the relevancy score assigned to the result such that a result having a higher relevancy score is deemed to be more relevant to the query. The results may be displayed in order based on relevancy scores in which results having a higher relevancy score appear earlier in the order. Thus, the most relevant result is displayed first and the least relevant result is displayed last.

In calculating the relevancy scores, the search engine 200 is configured to weight the keywords and/or other identifiers based on their order within the query. As an example, the first word of the query (which could the highest ranking hashtag when the query is generated based on a list of hashtags defined by the user) may be assigned the highest weight, and each subsequent hashtag, keyword and/or other identifier may be assigned a progressively lower weight such that the last keyword in the query is assigned the lowest weight. In addition, an identifier with a higher weight has a greater effect on the relevancy score when there is a match. Thus, the relevancy score of a result that matches higher-weighted identifiers generally may be higher than the relevancy score of a result that matches only lower-weighted identifiers even if the number of matching identifiers is the same for both results. Thus, the order of the identifiers in the query affects the ranking of the results. This is in stark contrast to many conventional search engines that treat each keyword the same when ranking the results of an Internet search or only allow searching one hashtag at a time.

Accordingly, if a user requests the search engine 200 to perform an Internet search of the hashtags that he or she has defined for his or her private hashtag list or other hashtag list, the order that the user has ranked the hashtags affects the results of the search and specifically the order that the results are returned to the user. However, the techniques described above are not limited to queries that involve hashtags and may be applied for other types of searches as may be desired.

Although the figures herein may show a specific order of method steps, the order of the steps may differ from what is depicted. Also, two or more steps may be performed concurrently or with partial concurrence. Variations in step performance can depend on the software and hardware systems chosen and on designer choice. All such variations are within the scope of the application. Software implementations could be accomplished with standard programming techniques, with rule based logic and other logic to accomplish the various connection steps, processing steps, comparison steps and decision steps.

It should be understood that the identified embodiments are offered by way of example only. Other substitutions, modifications, changes and omissions may be made in the design, operating conditions and arrangement of the embodiments without departing from the scope of the present application. Accordingly, the present application is not limited to a particular embodiment, but extends to various modifications that nevertheless fall within the scope of the application. It should also be understood that the phraseology and terminology employed herein is for the purpose of description only and should not be regarded as limiting.

What is claimed is:

1. A computer implemented method of managing hashtags, the method comprising:
transmitting hashtag data from a server to a user device over a network, wherein the hashtag data includes a first list of hashtags having a predetermined first order;
displaying the first list of hashtags on a user device for review by a user;
altering, by the user, the first list of hashtags on the user device to generate a second list of hashtags having a second order;
sending the second list of hashtags to the server;
associating the second list of hashtags to the user and storing the second list of hashtags in the server with an association to the user; and
updating the first list of hashtags in view of the second list of hashtags from the user.

2. The method of claim 1, further comprising:
selecting one or more hashtags to share on a social media platform; and
providing the selected one or more hashtags to a server of the social media platform in a message.

3. The method of claim 2, wherein the step of selecting one or more hashtags includes selecting hashtags from one of the first list of hashtags or the second list of hashtags.

4. The method of claim 2, wherein the step of providing the selected one or more hashtags includes:
storing the selected one or more hashtags on the user device;
automatically generating the message in response to a selection of an icon associated with the social media platform; and
automatically inserting the stored selected one or more hashtags in the message.

5. The method of claim 1, wherein altering the first list of hashtags includes deleting hashtags from the first list of hashtags and rearranging a ranking of one or more hashtags in the first list of hashtags.

6. The method of claim 1, further comprising:
repeating the steps of transmitting hashtag data, displaying the first list of hashtags, altering the first list of hashtags, sending the second list of hashtags, and associating the second list of hashtags for at least one additional user; and
wherein the step of updating the first list of hashtags includes updating the first list of hashtags in view of the second list of hashtags from the user and the second list of hashtags from the at least one additional user.

7. The method of claim 1, further comprising generating the first list of hashtags from hashtags used by users of a social network environment provided by the server.

8. The method of claim 7, wherein the step of generating the first list of hashtags includes obtaining information about hashtags communicated via a social media platform.

9. The method of claim 1, further comprising:
updating the hashtag data to link a hashtag with each object that is tagged with the hashtag by users of a social network environment provided by the server; and
displaying, on a user device, each object associated with the hashtag in response to a user request to search the hashtag data for the hashtag.

10. The method of claim 1, further comprising updating the first list of hashtags based on an extent hashtags in the first list of hashtags are shared by users of a social network environment provided by the server, wherein hashtags shared more frequently have a higher ranking the first list of hashtags and hashtags shared less frequently have a lower ranking in the first list of hashtags.

11. The method of claim 1, further comprising:
entering a query into the user device by a user, wherein the query includes at least one of a hashtag or a keyword;
sending the entered query to the server;
performing a search of the network for items related to the query with a search engine stored on the server in response to receiving the query; and
displaying results of the search on the user device.

12. The method of claim 11, wherein the query includes a parameter list, the parameter list comprising one of a list of hashtags or a list of keywords, and the step of performing a search includes searching the network for items having one of more parameters from the parameter list.

13. The method of claim 12, further comprising altering, by the user, the parameter list to have an order indicating a relevance ranking of the parameters preferred by the user, wherein altering the parameter list includes deleting parameters from the parameter list and rearranging a ranking of one or more parameters in the parameter list.

14. The method of claim 13, wherein the step of displaying results includes prioritizing results of the search based on the order of parameters in the parameter list, wherein results having parameters higher in the order are given a higher priority for display on the user device and results having parameters lower in the order are given a lower priority for display on the user device.

15. A system for managing hashtags comprising:
a server, the server comprising logic configured to manage hashtag data, the hashtag data includes a first list of hashtags having a predetermined first order;
a user device connected to the server by a network, the user device configured to receive and display hashtag data from the server, the user device comprising an interface to permit a user to generate a second list of hashtags having a second order based on the first list of hashtags received with the hashtag data and provide the second list of hashtags to the server; and
wherein the logic is configured to update the predetermined order of the first list of hashtags in response to receiving the second list of hashtags from the user device.

16. The system of claim 15, wherein the interface of the user device is configured to permit a user to select one or more hashtags to share on a social media platform and provide the selected hashtags in a message to a second server associated with the social media platform.

17. The system of claim 16, wherein the selected one or more hashtags are chosen from one of the first list of hashtags or the second list of hashtags, the interface of the user device is configured to automatically generate the message in response to a selection of the social media platform and to automatically insert the selected one or more hashtags into the message.

18. The system of claim 15, wherein the interface of the user device is configured to permit a user to delete hashtags from the first list of hashtags and rearrange a ranking of one or more hashtags in the first list of hashtags to form the second list of hashtags.

19. The system of claim 15, wherein the second order of the second list of hashtags corresponds to a determination of relevance of the hashtags by the user.

20. The system of claim 15, wherein the hashtag data includes a list of objects associated with each hashtag in the hashtag data, the interface of the user device is configured to display the list of objects associated with a hashtag selected by a user.
